(19) United States
(12) Patent Application Publication
(10) Pub. No.: US 2006/0097597 A1
(43) Pub. Date: May 11, 2006

(54) Method for monitoring electrical insulation on a rotor of an electrical machine

(76) Inventor: Reinhold Koziel, Muelheima A.D. Ruhr (DE)

Correspondence Address: HARNESS, DICKEY & PIERCE, P.L.C., P.O.BOX 8910, RESTON, VA, 20195, US

(21) Appl. No.: 10/294,694

(22) Filed: Nov. 15, 2002

(30) Foreign Application Priority Data
Nov. 15, 2001 (EP) 01127157.4

(51) Int. Cl. H02K 3/00; H02K 1/00

(52) U.S. Cl. 310/179

(57) ABSTRACT

A method for monitoring electrical insulation on a rotor of an electrical machine having in each case one coil which is connected to each end of a rotor winding and in series with therewith. For this purpose, both a magnetic conductor of the rotor, in particular a laminated core, and a rotor circuit which is closed via the two coils are electrically conductively connected to a rotor frame at a point between the two coils. A current in the rotor circuit produces a magnetic field, the magnetic field of each coil being measured without making contact by way of an appropriate magnetic field sensor. A state change in the insulation is determined from a change in at least one measurement value by way of an evaluation unit. Also proposed is an electrical machine which is suitable for carrying out the method.

This application claims priority on European Patent Application number EP 011 27 157.4 filed Nov. 15, 2001, the entire contents of which are hereby incorporated herein by reference.

### FIELD OF THE INVENTION

The present invention generally relates to an electrical machine with winding insulation monitoring for a rotor winding.

### BACKGROUND OF THE INVENTION

The insulation on a winding for an electrical device, in particular an electrical machine or a transformer, may have various types of faults, such as insulation faults and the like. Particularly in the case of electrical machines, the windings and hence also the winding insulation are subject to particular mechanical loading, which leads to additional stress. This relates in particular to the winding on a rotor of the electrical machine. Furthermore, the winding of the electrical machine is also particularly highly stressed by operation from a converter, as is known from the prior art.

In order to keep the effects of an insulation fault low, the insulation on the winding is monitored during operation of the electrical machine, for example, in order to avoid greater damage by switching off the electrical machine in good time. Furthermore, the failure of an electrical machine in a process system can lead to dangerous states. The insulation of an electrical machine is thus continuously monitored in situations such as these.

Particular attention should in this case be paid to the insulation on the rotor winding. First, because the rotor winding is a mechanically moving element, access for instrumentation monitoring is more difficult than for the stator winding. Second, because the rotor winding experiences a greater load than the stator winding.

In order to monitor the insulation of the rotor winding, methods and apparatuses are known which, by way of example, a fault current is determined by way of a measurement device arranged in the rotor, and an appropriate signal is transmitted via sliding contacts to a monitoring device.

Furthermore, a leakage current from an electrical machine mounted in an insulated manner is also used as a measure of the state of the insulation. However, this measurement method cannot determine shorts between turns in the winding.

Further methods provide electronics which are mounted on the rotor, although the particularly severe mechanical load is in this case regarded as being disadvantageous.

It has been found to be disadvantageous that the signals are transmitted via sliding contacts. Firstly, the sliding contacts are subject to wear and, secondly, the operation of the electrical machine can prevent the use of sliding contacts in certain atmospheric conditions and/or environmental conditions.

### SUMMARY OF THE INVENTION

An embodiment of the present invention is generally based on an object of providing a method and an apparatus by way of which an insulation fault in a winding on a rotating element, in particular a rotor, of an electrical machine is identified without making electrical contact.

An embodiment of the present invention proposes a method for monitoring electrical insulation on a rotor of an electrical machine. Each of the rotor and the electrical machine include one coil, which is connected to each end of a rotor winding and in series therewith. Both a magnetic conductor of the rotor, in particular a laminated core, and a rotor circuit which is closed via the two coils are electrically conductively connected to a rotor frame at a point between the two coils. A current in the rotor circuit produces a magnetic field, and the magnetic field of each coil is measured without making contact by way of an appropriate magnetic field sensor. A state change in the insulation is determined from a change in at least one measurement value by way of an evaluation unit.

It is advantageously possible to avoid the transmission of measurement values via sliding contacts, and the problems which are associated with this. Thus, for example, the accuracy of transmitted analog measurement signals can be increased, since disturbance influences such as a change in the contact resistance of a sliding contact cannot have any effects. Furthermore, the sliding contact can no longer have any disadvantageous influence on small measurement signals. Furthermore, it is possible to determine the location of an insulation fault in the winding. In this case, the method can be used equally well for direct current machines as for 3-phase machines, in particular synchronous machines, and irrespective of whether they are being operated as a generator or as a motor. Moreover, there is no need to provide any measurement electronics on the rotor.

An embodiment of the present invention further proposes that the coils and/or magnetic field sensors are connected such that a frame short is determined by a difference signal for a rotor circuit which is electrically conductively connected to the rotor frame at a point. It is possible to deduce the nature of an insulation fault, such as a short between turns or a frame short, for example by the nature of the measurement signal per se.

An embodiment of the present invention furthermore proposes an electrical machine having a rotor which has a rotor winding and a magnetic conductor, in particular a laminated core. A coil is connected in series to each end of the rotor winding, and in which both the magnetic conductor of the rotor and a rotor circuit which is closed via the two coils are electrically conductively connected to a rotor frame at a point between the two coils. Therefore, the measurement values which relate to the winding insulation are detected and are transmitted without making contact and substantially without any maintenance, for further processing. Furthermore, any inadvertent influence on the measurement values, for example, resulting from sliding contacts, can be avoided, and the measurement accuracy can be increased.

An embodiment of the present invention proposes that the coil be a pot-type coil. A pot-type coil can produce a magnetic field which is directed at a small spatial area thus making it possible to produce a magnetic signal which can be evaluated well in that area, for given magnetic excitation. Any influence from disturbance fields can also be reduced. Furthermore, however, other suitable coil types, such as rod coils or coils provided with magnetic ferrite conductors and the like can also be used.

An embodiment of the present invention also proposes that the coils be arranged at one axial rotor end. The magnetic field which is required for the measurement advantageously acts in an area which is physically different from that in which the operating magnetic field of the electrical machine acts. This makes it possible to achieve high measurement sensitivity and a simple arrangement of the measurement sensors.

An embodiment of the present invention furthermore proposes that a magnetic field sensor which is connected to an evaluation unit be provided in each case for measuring the magnetic field of the coils. A measurement signal which can be processed by an evaluation unit is advantageously obtained from the magnetic field of the coils. In this case, the sensor may comprise a further coil or the like, and may be provided as an element of the electrical machine. In addition, the magnetic field sensor may also be provided as an element that is not part of the machine, at a suitable point. It is thus also possible, for example, to retrofit an electrical machine with such a measurement arrangement.

Still further, an embodiment of the present invention furthermore proposes that the magnetic field sensor be a Hall sensor. As a fast-reaction and accurate measurement sensor, a Hall element is particularly suitable for measuring the magnetic field of the coils. Furthermore, the Hall sensor may be physically small and can thus easily be integrated in an existing machine structure.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a section through a basic design of a synchronous machine;

FIG. 2 illustrates an outline circuit diagram of an arrangement for carrying out a method according to an embodiment of the present invention;

FIG. 3 illustrates a side view of the synchronous machine; and

FIG. 4 illustrates an enlargement of the detail IV illustrated in FIG. 3.

### DETAILED DESCRIPTION OF THE PREFERRED EMBODIMENTS

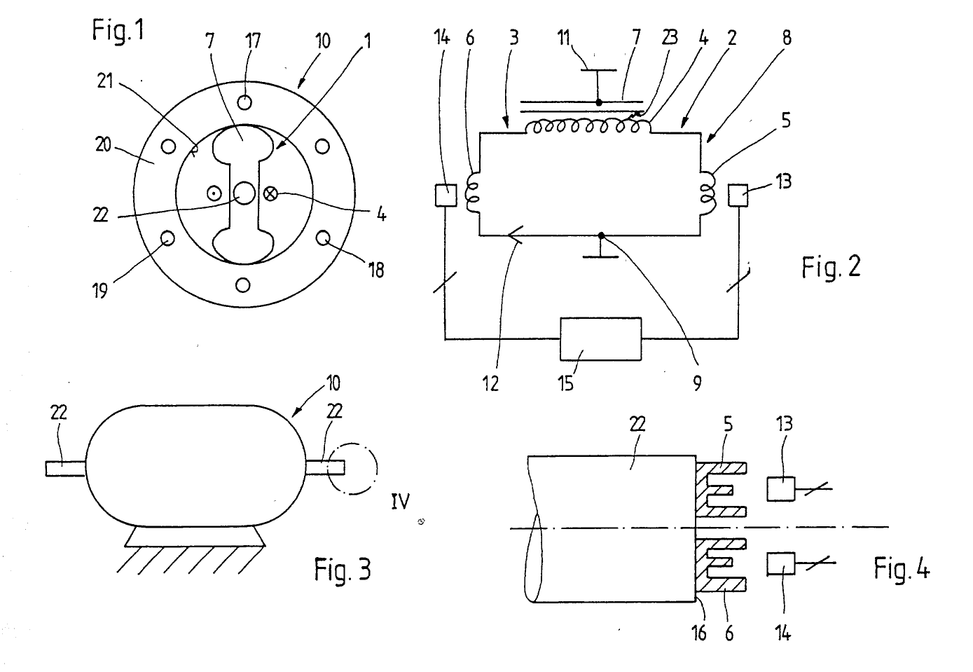

Further details, features and advantages of the invention can be found in the following description of the exemplary embodiments. Components which essentially remain the same are denoted by the same reference symbols. Furthermore, with regard to the same features and functions, reference is made to the description of the exemplary embodiment in FIG. 1.

FIG. 1 shows a section through a basic design of a synchronous machine 10. A cylindrical stator 20 with an inner opening 21 has three stator windings 17, 18, 19, which are connected to the respective phase of a 3-phase power supply system, which is not shown in specific detail. A rotor 1 is mounted within the opening 21, such that it can rotate. The rotor 1 has a shaft 22.

In order to monitor electrical insulation on the rotor 1 of the synchronous machine 10, this rotor 1 has coils 5, 6 which are connected to each end 2, 3 of a rotor winding 4, in series with it (FIG. 2). Both a laminated core 7 of the rotor 1 and a rotor circuit 8 which is closed via the two coils 5, 6 are electrically conductively connected to a rotor frame 11 at a point 9 between the two coils 5, 6. A current 12 in the rotor circuit 8 produces a magnetic field. The magnetic field of each coil 5, 6 is measured without making contact by way of an appropriate magnetic field sensor 13, 14, and a state change in the insulation is determined from a change in at least one measurement value, by way of an evaluation unit 15. The evaluation unit 15 may, for example, initiate an alarm and/or switch off the synchronous machine 10 when a limit value is infringed.

If, for example, an insulation fault which results in a short between turns occurs between two physically adjacent turns in the rotor winding 4, the current 12 in the rotor circuit 8 increases, as a result of which the magnetic field produced by the coils 5, 6 also increases. This change in the magnetic field is detected by the Hall sensors 13, 14 which are connected to the evaluation unit 15. The evaluation unit 15 determines a change and/or a discrepancy from predetermined limit values. If a limit value is infringed, an alarm is initiated and the synchronous machine 10 is switched off. The alarm may in this case be in the form of a local alarm, such as a warning lamp, or else may be in the form of a signal to a remote control center.

Furthermore, the coils 5, 6 and/or the magnetic field sensors 13, 14 are connected such that a frame short is determined by a difference signal for a rotor circuit 8 which is electrically conductively connected to the rotor frame 11 at a point 9. In the event of an insulation fault to the rotor frame 7, a further circuit is produced via the fault location 23 in the rotor winding 4 to the laminated core 7, from the laminated core 7 via the rotor frame 11 to the point 9 (FIG. 2). The current 12 which flows through the coil 6 is split at the point of the insulation fault, so that only a reduced current flows through the coil 5. This difference is detected by the evaluation unit.

In order to use the method, a coil 5, 6 is connected to each end of the rotor winding 2, 3, in series with it, in the synchronous machine 10. In this case, the coils 5, 6 are in the form of pot-type coils (FIGS. 3, 4). This configuration of the coils 5, 6 as pot-type coils means firstly that the magnetic field is concentrated in the direction of the Hall sensor, in order to reduce the influence of disturbances and, secondly, that the measurement accuracy can be increased with little energy consumption.

A magnetic field sensor 13, 14 which is connected to the evaluation unit 15 is in each case provided in order to measure the magnetic field of the coils 5, 6.

In this case, the coils 5, 6 are arranged at an axial rotor end 16, formed by the shaft 22. The Hall sensors 13, 14 are arranged immediately in front of these coils 5, 6. During each revolution of the shaft 22, the two coils 5, 6 are in each case located in front of the appropriate Hall sensors 13, 14 for an appropriate instant of time, so that the magnetic field can be measured. However, as an alternative, the coils 5, 6 may also be mounted radially on the shaft 22.

Furthermore, the entire arrangement may also be arranged within the machine 10, thus forming a closed unit.

The exemplary embodiments illustrated in the figures serve merely to explain the present invention; therefore, the present invention should not be construed as being restricted thereby. Thus, in particular, individual method steps as well as the additional functions such as determination of the type of fault, etc. may vary.

What is claimed is:

1. A method for monitoring electrical insulation on a rotor of an electrical machine, the electrical machine having a coil connected to each end of a rotor winding and in series therewith, both a magnetic conductor of the rotor and a rotor circuit that is closed via the two coils are electrically conductively connected to a rotor frame at a point between the two coils, and wherein a current in the rotor circuit produces a magnetic field, the method comprising:
measuring a magnetic field of each coil without making contact therewith by way of a magnetic field sensor; and
determining a state change in the insulation from a change in at least one measurement value by way of an evaluation unit.

2. The method as claimed in claim 1, further comprising determining a frame short by a difference signal for a rotor circuit, the rotor circuit being electrically conductively connected to the rotor frame at the point.

3. An electrical machine, comprising:
a rotor having a rotor winding and a magnetic conductor; and
a coil connected in series with each end of the rotor winding,
wherein both the magnetic conductor of the rotor and a rotor circuit which is closed via the two coils are electrically conductively connected to a rotor frame at a point between the two coils.

4. The electrical machine as claimed in claim 3, wherein at least one of the coils is a pot-type coil.

5. The electrical machine as claimed in claim 3, wherein the coils are arranged at one axial rotor end.

6. The electrical machine as claimed in claim 3, further comprising a magnetic field sensor being connected to an evaluation unit, the magnetic field sensor for measuring a magnetic field of the coils.

7. The electrical machine as claimed in claim 3, wherein the magnetic field sensor is a Hall sensor.

8. The electrical machine as claimed in claim 4, wherein the coils are arranged at one axial rotor end.

9. The electrical machine as claimed in claim 4, further comprising a magnetic field sensor being connected to an evaluation unit, the magnetic field sensor for measuring a magnetic field of the coils.

10. The electrical machine as claimed in claim 5, further comprising a magnetic field sensor being connected to an evaluation unit, the magnetic field sensor for measuring a magnetic field of the coils.

11. The electrical machine as claimed in claim 4, wherein the magnetic field sensor is a Hall sensor.

12. The electrical machine as claimed in claim 5, wherein the magnetic field sensor is a Hall sensor.

13. The electrical machine as claimed in claim 6, wherein the magnetic field sensor is a Hall sensor.

14. The electrical machine according to claim 3, wherein the machine performs the method according to claim 1.

15. The method according the claim 1, wherein the magnetic conductor is a laminated core.

16. The electrical machine according to claim 3, wherein the magnetic conductor is a laminated core.
